(19) United States
(12) Patent Application Publication
(10) Pub. No.: US 2026/0211757 A1
(43) Pub. Date: Jul. 23, 2026

(54) DATA SAMPLING FRAMEWORK

(71) Applicant: Capital One Services, LLC, McLean, VA (US)

(72) Inventors: Hao CHENG, Oakton, VA (US); Marek BAZLER, Glen Allen, VA (US); Venu Kumar NANNAPANENI, Glen Allen, VA (US); Ashish Prasad GUPTA, Richmond, VA (US)

(21) Appl. No.: 19/035,074

(22) Filed: Jan. 23, 2025

(51) Int. Cl. G06F 9/54

(52) U.S. Cl. CPC G06F 9/546

(57) ABSTRACT

In some implementations, a data sampling system may receive one or more sample data messages. The data sampling system may store the one or more sample data messages in a message queue. The data sampling system may generate, based on the one or more sample data messages, one or more data segments. The data sampling system may generate, based on the one or more data segments, one or more aggregate data messages. The data sampling system may transmit the one or more aggregate data messages via a network channel.

### BACKGROUND

An application program interface (API) is a software intermediary that allows unrelated applications to communicate with each other. For example, the API generally acts like a bridge to take a request or a message from a first application, translate the request or message into a format compatible with a second application and/or perform one or more protocols based on what the API is programmed to do, and then deliver the (translated) request or message to the second application. APIs may use various routines, tools, and/or protocols to specify how different software components and/or applications are to function together.

### SUMMARY

Some implementations described herein relate to a system for data sampling. The system may include a first device and a second device. The first device may comprise one or more memories and one or more processors communicatively coupled to the one or more memories. The second device may comprise one or more memories and one or more processors communicatively coupled to the one or more memories. The one or more processors of the first device may be configured to obtain, using an API, one or more sample data messages from among a plurality of data messages. The one or more processors of the first device may be configured to store the one or more sample data messages in a first message queue. The one or more processors of the first device may be configured to retrieve the one or more sample data messages from the first message queue. The one or more processors of the first device may be configured to generate, based on the one or more sample data messages, one or more data segments that include data carried in the one or more sample data messages. The one or more processors of the first device may be configured to generate, based on the one or more data segments, one or more aggregate data messages that include data carried in the one or more data segments. The one or more processors of the first device may be configured to transmit the one or more aggregate data messages via a network channel. The one or more processors of the second device may be configured to receive the one or more aggregate data messages via the network channel. The one or more processors of the second device may be configured to load-balance the one or more aggregate data messages across a plurality of de-aggregators. The one or more processors of the second device may be configured to generate, using at least one de-aggregator of the plurality of de-aggregators, based on the one or more aggregate data messages, the one or more data segments. The one or more processors of the second device may be configured to generate, based on the one or more data segments, the one or more sample data messages. The one or more processors of the second device may be configured to store the one or more sample data messages in a second message queue. The one or more processors of the second device may be configured to retrieve the one or more sample data messages from the second message queue. The one or more processors of the second device may be configured to cause the one or more sample data messages to be stored in a data sink.

Some implementations described herein relate to a method of data sampling. The method may include obtaining, using an API, one or more sample data messages from among a plurality of data messages, wherein each of the one or more sample data messages comprises an API sample data format that includes a message identifier field, a metadata field, and a payload field. The method may include storing the one or more sample data messages in a message queue. The method may include retrieving the one or more sample data messages from the message queue. The method may include generating, based on the one or more sample data messages, one or more data segments that include data carried in the one or more sample data messages, wherein each of the one or more data segments includes the message identifier field, a segmentation flag field, a segment identifier field, and a data field. The method may include generating, based on the one or more data segments, one or more aggregate data messages that include data carried in the one or more data segments, wherein each of the one or more aggregate data messages includes a count field, one or more segment length fields, and one or more segment data fields corresponding to the one or more segment length fields. The method may include transmitting the one or more aggregate data messages via a network channel.

Some implementations described herein relate to another method of data sampling. The other method may include receiving one or more aggregate data messages via a network channel, wherein each of the one or more aggregate data messages includes a count field, one or more segment length fields, and one or more segment data fields corresponding to the one or more segment length fields. The other method may include load-balancing the one or more aggregate data messages across a plurality of de-aggregators. The other method may include generating, using at least one de-aggregator of the plurality of de-aggregators, based on the one or more aggregate data messages, one or more data segments that include data carried in the one or more aggregate data messages, wherein each of the one or more data segments includes a message identifier field, a segmentation flag field, a segment identifier field, and a data field. The other method may include generating, based on the one or more data segments, one or more sample data messages that include data carried in the one or more data segments, wherein each of the one or more sample data messages comprises an API sample data format that includes the message identifier field, a metadata field, and a payload field. The other method may include storing the one or more sample data messages in a message queue. The other method may include retrieving the one or more sample data messages from the message queue. The other method may include causing the one or more sample data messages to be stored in a data sink.

### BRIEF DESCRIPTION OF THE DRAWINGS

FIGS. 1A-1B are diagrams of an example associated with a data sampling framework, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with data sampling, in accordance with some embodiments of the present disclosure.

FIG. 4 is a flowchart of an example process associated with data sampling, in accordance with some embodiments of the present disclosure.

FIG. 5 is a flowchart of an example process associated with data sampling, in accordance with some embodiments of the present disclosure.

### DETAILED DESCRIPTION

The following detailed description of example implementations refers to the accompanying drawings. The same reference numbers in different drawings may identify the same or similar elements.

In some cases, data sets may be restrictively large such that analysis of the data may be impractical. Data sampling involves selecting a subset of the data for analysis, rather than the entire data set. Data sampling has various applications, such as sensitive data scans, A/B testing, or the like. In some examples, data sampling may involve collecting data from a service (e.g., an API service) and pushing the data to storage for analysis. For example, a sending side may collect the data from the API service and transmit the sampled data over a network channel to the receiving side, and the receiving side may push the data to the storage for analysis.

However, network congestion or slowness on the receiving side or in the network channel between the receiving side and the sending side can create back-pressure, causing delays in sending operations, and, thus, impact API service. For example, the API service may need to wait for the sending side to complete certain sending operations before proceeding with additional data sampling, which may consume excessive processing or memory resources. Furthermore, the data may be sent to the storage inefficiently. For example, if the network channel is experiencing slowness, and/or if network messages containing the sampled data are not optimal sizes for the network channel, then the sampled data may be delayed in arriving at the storage, which may consume excessive processing or memory resources. Moreover, in at least some cases, data sampling is not scalable, and, therefore, may contribute to slowness and/or use excessive processing or memory resources.

Some implementations described herein enable an API data sampling framework that includes a sender (where the data is sampled) and a receiver (where the data is pushed for storage). At the sender, an API sampling engine collects sample data messages and pushes the sample data messages to a message queue. One or more fragmentors pull the sample data messages from the message queue and fragment the sample data messages into data segments. An aggregator may aggregate the data segments into one or more aggregate data messages. For example, the aggregator may aggregate the data segments such that sizes of the aggregate data messages are close to a maximum transmission unit (MTU), which is a maximum allowable protocol data unit (PDU) size of a network channel. The sender may transmit the aggregate data messages over a network channel to the receiver. At the receiver, the aggregate data messages may be load-balanced to one or more de-aggregators that fragment the aggregate data messages into the data segments. The data segments may be hashed to one or more re-assemblers that recover the sample data messages from the data segments. The re-assemblers may push the sample data messages to another message queue, and the sample data messages may be transmitted for storage in a data sink.

As a result, processing or memory resources may be consumed in an efficient manner. For example, the API data sampling framework provides multiple points at which to relieve back-pressure automatically, thereby avoiding overconsumption of processing or memory resources. For example, if the sample data messages stored in the messaging queues are experiencing slowness, then those sample data messages may be dropped. In this manner, the messaging queues may help to release back-pressure. Furthermore, the API data sampling framework may permit the API sampling engine to perform efficiently. For example, instead of waiting for back-pressure to resolve, the API sampling engine may push sample data messages to collocated messaging queues, and may perform one or more other operations as needed (e.g., batch, retry, backoff, or the like). Additionally, or alternatively, the API data sampling framework may leverage reliable inter-process communication (IPC) solutions (e.g., datagram Unix domain sockets (UDS), shared memory, pipes, or the like) to further increase size limits (e.g., UDS may manage 8 gigabits per second). Moreover, the API data sampling framework may provide a scalable solution, which may help to further reduce processing or memory resource consumption. Available resources (e.g., central processing unit (CPU) resources, memory resources, or the like) may be used efficiently by load-balancing across multiple senders and/or fragmentors, or auto-scaling the receiver (e.g., a receive cluster), re-assemblers, de-aggregators, collocated senders, and/or other sender-side or receiver-side components up or down based on load. Thus, the API data sampling framework may enable high sampling, network, and storage efficiency. The fragmentors, de-aggregators, and re-assemblers may help to achieve transmission efficiency by reducing retransmissions in lossy networks by addressing network limitations (e.g., noise, slowness, or the like). For example, if a message with 5 megabytes (MBs) is lost, then the sender may retransmit all 5 megabytes; however, if the message is split into five 1 MB data segments, then the sender may retransmit only the 1 MB data segment that was lost. Moreover, the fragmentors, de-aggregators, and re-assemblers may optimally size the aggregate data messages (e.g., by generating aggregate data messages having sizes close to the MTU) for network transmission. For example, small-sized messages (e.g., on the order of 100 bytes, 10 kilobytes (KB), or 100 KB) may be packed, which may help to improve channel efficiency between the sender and the receiver (e.g., the most efficient size may be 1 MB).

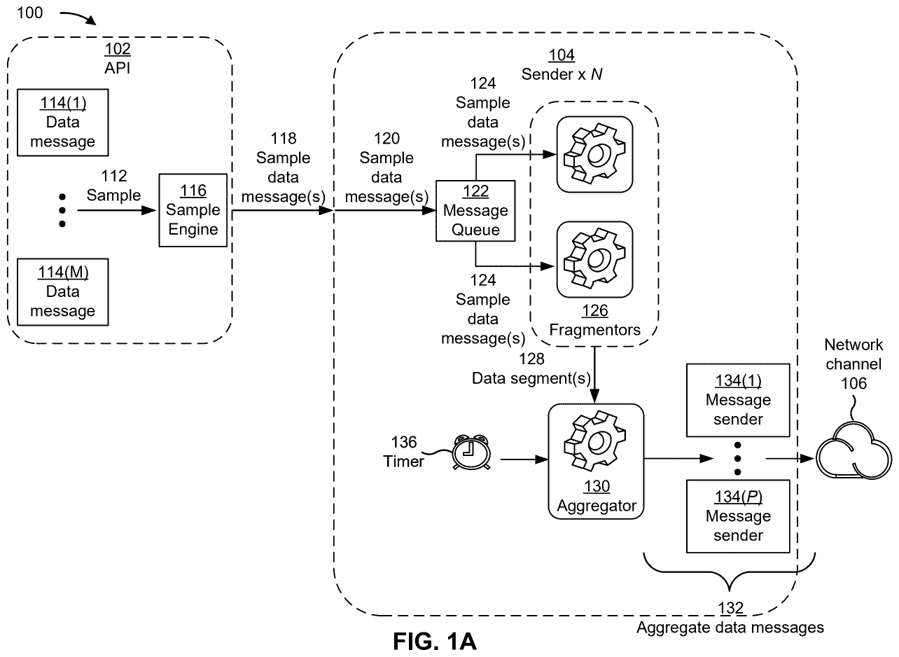

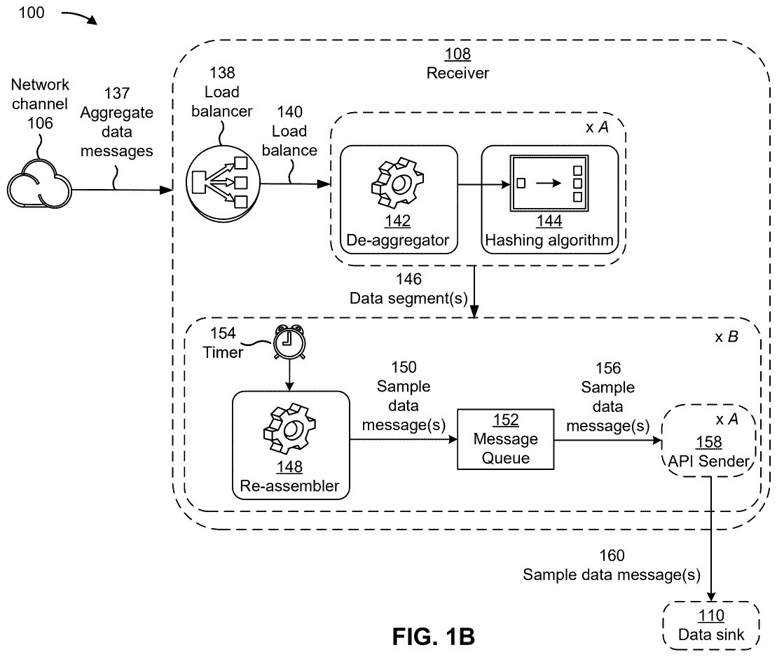

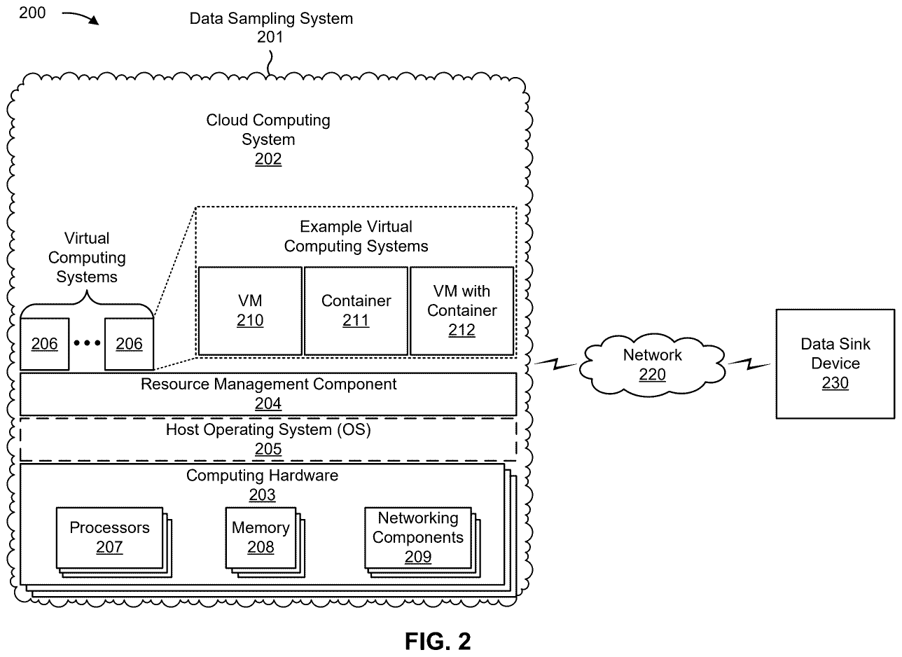

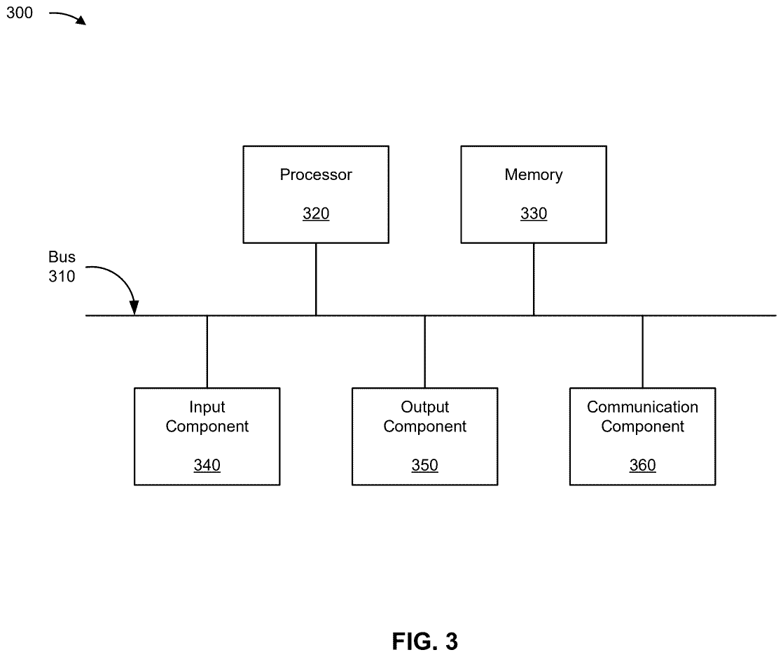

FIGS. 1A-1B are diagrams of an example 100 associated with a data sampling framework. As shown in FIGS. 1A-1B, example 100 includes an API 102, a sender 104, a network channel 106, a receiver 108, and a data sink 110. In some aspects, the sender 104 may comprise a first device, and the receiver 108 may comprise a second device. These devices are described in more detail in connection with FIGS. 2 and 3.

With reference to FIG. 1A, shown are sender-side operations. As shown by reference number 112, the API 102 (e.g., a data sampling API) may sample data messages 114(1)-114(M) to obtain one or more sample data messages. For example, the one or more sample data messages may be a subset of the data messages 114(1)-114(M). The API 102 may use a sample engine 116 to sample the data messages 114(1)-114(M).

In some aspects, each of the one or more sample data messages may comprise an API sample data format that includes a message identifier field, a metadata field, and a payload field. The message identifier field may indicate an identifier of the message. In some examples, the message identifier field may be globally unique. The metadata field may contain information including time associated with the sample data message, an internet protocol (IP) address and/or port associated with the sample data message, an identifier of the API 102, or the like. Table 1 below shows an example API sample data format.

TABLE 1

| | | |
|---|---|---|
| Message identifier field | Metadata field | Payload field |

As shown by reference number 118, the sender 104 may obtain, using the API 102, the one or more sample data messages from among the data messages 114(1)-114(M). For example, the sample engine 116 may provide the sample data message(s) to the sender 104.

As shown by reference number 120, the sender 104 may store the one or more sample data messages in a first message queue 122 (e.g., a buffer queue). The first message queue 122 may temporarily store the one or more sample data messages. As shown by reference number 124, the sender 104 may retrieve the one or more sample data messages from the first message queue 122.

In some aspects, the sender 104 may generate, based on the one or more sample data messages, one or more data segments that include data carried in the one or more sample data messages. For example, the one or more data segments that include data carried in the payload field(s) of the one or more sample data messages. In cases where fragmentation is disabled (e.g., because the network channel 106 is high-speed and/or reliable), the sender 104 may generate a single data segment based on a single sample data message. In cases where fragmentation is enabled (e.g., because the network channel 106 is unreliable), the sender 104 may generate a plurality of data segments based on a single sample data message. For example, one or more fragmentors 126 (e.g., fragment handlers) may pull the one or more sample data messages from the first message queue 122 and generate the one or more data segments. In cases where fragmentation is enabled, the size of the data segments may be configurable (e.g., the size of the data segments may be configured based on (e.g., optimized for) the MTU of the network channel 106).

In some aspects, each of the one or more data segments may include a message identifier field, a segmentation flag field, a segment identifier field, and a data field. The message identifier field of a data segment may indicate the same value as indicated in the message identifier field of the sample data message that was used to generate the data segment. The segmentation flag field may indicate whether fragmentation is enabled (e.g., “ON”) or disabled (e.g., “OFF”). Additionally, or alternatively, the segmentation flag field of the data segment may contain an “IsLast” indicator that identifies whether the data segment is a last data segment generated from the sample data message. The segment identifier field may indicate an identifier of the data segment. Data segment identifiers may be assigned sequentially (e.g., 0, 1, 2, and so forth). The data field of the data segment may contain some or all of the information contained in the payload field of the of the sample data message that was used to generate the data segment. Table 2 below shows an example data segment format.

TABLE 2

| | | | |
|---|---|---|---|
| Message identifier | Segmentation flag | Segment identifier | Data |
| field | field | field | field |

In some aspects, the sender 104 may generate, based on the one or more data segments, one or more aggregate data messages that include data carried in the one or more data segments. For example, the one or more aggregate data messages may include data carried in the data field(s) of the one or more data segments. As shown by reference number 128, the one or more fragmentors 126 may provide the one or more data segments to an aggregator 130, which may aggregate the one or more data segments into the aggregate data message(s).

In some aspects, each of the one or more aggregate data messages may include a count field, one or more segment length fields, and one or more segment data fields corresponding to the one or more segment length fields. A count field may indicate a quantity of data segments that are present in an aggregate data message. A segment length field may indicate a size of a corresponding data segment. A segment data field may contain data carried by a corresponding data segment. Table 2 below shows an example aggregate data message format.

TABLE 3

| | | | | | |
|---|---|---|---|---|---|
| Count | Segment | Segment | . . . | Segment | Segment |
| field | length | data | | length | data |
| | field #0 | field #0 | | field #X | field #X |

As shown by reference number 132, the sender 104 may transmit the one or more aggregate data messages via the network channel 106. For example, the aggregator 130 may provide the one or more aggregate data messages to message senders 134(1)-134(P), which may transmit the aggregate data message(s) via the network channel 106. The network channel 106 may include one or more wired and/or wireless connections configured to carry the aggregate data message(s).

In some aspects, the sender 104 may transmit the one or more aggregate data messages based on one or more of an MTU or a timer 136. For example, the aggregator 130 may aggregate one or more data segments and provide an aggregate data message to the message senders 134(1)-134(P) based on a size of the aggregate data message being as close as possible to an MTU without exceeding the MTU. Additionally, or alternatively, the aggregator 130 may aggregate one or more data segments and provide an aggregate data message to the message senders 134(1)-134(P) based on an expiration of the timer 136. For example, the aggregator 130 may cause the aggregate data message to be force-sent upon timeout, regardless of the size of the aggregate data message (e.g., the aggregation may be opportunistic). For example, the timer 136 may prompt the aggregator 130 to provide an aggregate data message that has a size less than the MTU to the message senders 134(1)-134(P), instead of waiting for additional data segments to aggregate.

With reference to FIG. 1B, shown are receiver-side operations. As shown by reference number 137, the receiver 108 may receive the one or more aggregate data messages via the network channel 106. For example, a load balancer 138 may receive the one or more aggregate data messages from the message senders 134(1)-134(P) via the network channel 106.

As shown by reference number 140, the receiver 108 (e.g., the load balancer 138) may load-balance the one or more aggregate data messages across a plurality of de-aggregators 142. For example, the load balancer 138 may distribute the aggregate data messages across de-aggregators 142. A de-aggregator may be a functionality configured to split an aggregate data message into the one or more data segments.

In some aspects, the receiver 108 may generate, using at least one de-aggregator of the plurality of de-aggregators 142, based on the one or more aggregate data messages, the one or more data segments. For example, a de-aggregator 142 may split an aggregate data message into the one or more data segments. In some examples, where fragmentation is enabled (e.g., the segmentation flag field is set to “ON”), the de-aggregator 142 may use a hashing algorithm 144 to hash the one or more data segments based on one or more message identifier fields of the data segment(s).

In some aspects, the receiver 108 may generate, based on the one or more data segments, the one or more sample data messages. As shown by reference number 146, a de-aggregator 142 may forward the one or more data segments to one or more re-assemblers 148. In some examples, where fragmentation is enabled, the de-aggregator 142 may identify the one or more re-assemblers 148 using the hashing algorithm 144 for consistent reassembly (e.g., the de-aggregator 142 may hash the one or more data segments to the one or more re-assemblers 148). In some examples, where fragmentation is disabled (e.g., the segmentation flag field is set to “OFF”), the de-aggregator 142 may forward the data segment to any of the re-assemblers 148. In some examples, where fragmentation is enabled, the re-assembler 148 may restore the one or more sample data messages using the one or more data segments.

As shown by reference number 150, the receiver 108 may store the one or more sample data messages in a second message queue 152 (e.g., a buffer queue). For example, the re-assembler 148 may push the one or more sample data messages to the second message queue 152 before expiration of a timer 154. The second message queue 152 may temporarily store the one or more sample data messages. As shown by reference number 156, the sender 104 may retrieve the one or more sample data messages from the second message queue 152. For example, an API sender 158 may retrieve the one or more sample data messages from the second message queue 152. For example, the API sender 158 may retrieve the one or more sample data messages from the second message queue 152 using a simple queue service (SQS).

In some aspects, the receiver 108 may cause the one or more sample data messages to be stored in the data sink 110 (e.g., data storage). For example, the API sender 158 may use a restful API to reformat the one or more sample data messages in accordance with an API specification defined by the data sink 110. As shown by reference number 160, the API sender 158 may transmit, and the data sink 110 may receive, the one or more sample data messages. For example, the API sender 158 may publish the one or more sample data messages to the data sink 110.

Several example implementations are described as follows with reference to FIGS. 1A and 1B.

In a first example implementation, fragmentation may be on, and a sample data message may have a small payload. The sample engine 116 may collect a sample data message according to one or more sampling rules and push the sample data message to the first message queue 122 of the sender 104. The sample data message may have a message identifier of 1000 and may include metadata and the small payload. In some aspects, a segmentation flag of the single data segment may be set to on. For example, fragmentation may be enabled.

In some aspects, the sender 104 may generate a single data segment based on the sample data message. For example, one of the fragmentors 126 may retrieve the sample data message from the first message queue 122 and generate a single data segment based on the sample data message because the sample data message has a small payload. The single data segment may have a message identifier of 1000, a segmentation flag set to “ON” (e.g., “1”), an “IsLast” indicator indicating that the single data segment is a last data segment generated from the sample data message (e.g., a bit set to “1”), and a data segment identifier of 0.

An aggregator 130 may combine the single data segment with one or more other data segments received from one or more fragmentors 126 to generate an aggregate data message. For example, the aggregate data message may include a count field indicating that the aggregate data message includes three data segments having message identifiers 999, 1000, and 1001, respectively. One of the message senders 134(1)-134(P) may send the aggregate data message to the receiver 108 (e.g., a receiver cluster).

In some aspects, the receiver 108 may generate the sample data message based on the single data segment. For example, the load balancer 138 may forward the aggregate data message to one of the de-aggregators 142, which may split the aggregate data message into the three data segments, including the single data segment. The de-aggregator 142 may forward the three data segments, including the single data segment, to one or more re-assemblers 148 using hashing of the message identifiers. For example, the data segment having the message identifier 999 may be forwarded to a re-assembler 148(7); the single data segment (having the message identifier 1000) may be forwarded to a re-assembler 148(1); and so forth.

The re-assemblers 148 may reassemble the data segments into a sample data message format. Upon receiving the single data segment, the re-assembler 148(1) may determine that the single data segment is the only data segment for the sample data message, and, thus, that all data segments for the sample data message have been received. Therefore, the re-assembler 148(1) may place the sample data message in the second message queue 152. One of the API senders 158 may retrieve the sample data message from the second message queue 152 and send the sample data message to the data sink 110.

In a second example implementation, fragmentation may be on, and a sample data message may have a large payload. The sample engine 116 may collect a sample data message according to one or more sampling rules and push the sample data message to the first message queue 122 of the sender 104. The sample data message may have a message identifier of 1000 and may include metadata and the large payload.

In some aspects, the sender 104 may generate a plurality of data segments, of the one or more data segments, based on a sample data message of the one or more sample data messages. For example, one of the fragmentors 126 may retrieve the sample data message from the first message queue 122 and generate the plurality of data segments based on the sample data message because the sample data message has a large payload. For example, the fragmentor 126 may create 20 data segments based on the sample data message. The first data segment may have a message identifier of 1000, a segmentation flag set to “ON” (e.g., “1”), an “IsLast” indicator indicating that the first data segment is not a last data segment generated from the sample data message (e.g., a bit set to “0”), and a data segment identifier of 0; the second data segment may have a message identifier of 1000, a segmentation flag set to “ON” (e.g., “1”), an “IsLast” indicator indicating that the first data segment is not a last data segment generated from the sample data message (e.g., a bit set to “0”), and a data segment identifier of 1; and so forth. The twentieth data segment may have a message identifier of 1000, a segmentation flag set to “ON” (e.g., “1”), an “IsLast” indicator indicating that the first data segment is a last data segment generated from the sample data message (e.g., a bit set to “1”), and a data segment identifier of 19.

An aggregator 130 may combine multiple data segments, including the plurality of data segments, received from one or more fragmentors 126 to generate one or more aggregate data messages. For example, a first aggregate data message may include a count field indicating that the aggregate data message includes three data segments having message identifiers 999, 1000, and 1001, respectively. The data segment having the message identifier of 1000 may have a data segment identifier of 0. A second aggregate data message may include a count field indicating that the aggregate data message includes ten data segments. The ten data segments may each have message identifier 1000 and respective data segment identifiers 1-10. A third aggregate data message may include a count field indicating that the aggregate data message includes ten data segments. Nine of the data segments may have message identifier 1000 and respective data segment identifiers 11-19, and the tenth data segment may have message identifier 1002. One or more of the message senders 134(1)-134(P) may send the aggregate data messages to the receiver 108.

In some aspects, the receiver 108 may generate the sample data message based on the plurality of data segments. For example, the load balancer 138 may forward the aggregate data messages to one or more of the de-aggregators 142, which may split the aggregate data message into the multiple data segments, including the plurality of data segments. The de-aggregator 142 may forward the multiple data segments, including the plurality of data segments, to one or more re-assemblers 148 using hashing of the message identifiers. For example, for the first aggregate data message, the data segment having the message identifier 999 may be forwarded to a re-assembler 148(7), and the data segment having the message identifier 1000 may be forwarded to a re-assembler 148(1). For the second aggregate data message, all of the data segments (having the message identifier 1000) may be forwarded to the re-assembler 148(1). For the third aggregate data message, the data segments having the message identifier 1000 may be forwarded to the re-assembler 148(1), and the data segment having the message identifier 1002 may be forwarded to a re-assembler 148(5).

The re-assemblers 148 may reassemble the data segments into a sample data message format. In some examples, the re-assembler 148(1) may receive the plurality of data segments out of order. For example, the re-assembler 148(1) may first receive the twentieth data segment (having a segment identifier of 19), and then receive the remaining data segments (having segment identifiers 0-18). Upon receiving all data segments of the plurality of data segments, the re-assembler 148(1) may generate the sample data message and place the sample data message in the second message queue 152. One of the API senders 158 may retrieve the sample data message from the second message queue 152 and send the sample data message to the data sink 110.

In a third example implementation, fragmentation may be off. The sample engine 116 may collect a sample data message according to one or more sampling rules and push the sample data message to the first message queue 122 of the sender 104. The sample data message may have a message identifier of 1000 and may include metadata and a payload. In some aspects, a segmentation flag of the single data segment may be set to off. For example, fragmentation may be disabled.

In some aspects, the sender 104 may generate a single data segment based on the sample data message. For example, one of the fragmentors 126 may retrieve the sample data message from the first message queue 122 and generate a single data segment based on the sample data message because fragmentation is disabled. The single data segment may have a message identifier of 1000, a segmentation flag set to “OFF” (e.g., “0”), an “IsLast” indicator indicating that the single data segment is a last data segment generated from the sample data message (e.g., a bit set to “1”), and a data segment identifier of 0.

An aggregator 130 may combine the single data segment with one or more other data segments received from one or more fragmentors 126 to generate an aggregate data message. For example, the aggregate data message may include a count field indicating that the aggregate data message includes three data segments having message identifiers 999, 1000, and 1001, respectively. One of the message senders 134(1)-134(P) may send the aggregate data message to the receiver 108 (e.g., a receiver cluster).

In some aspects, the receiver 108 may generate the sample data message based on the single data segment. For example, the load balancer 138 may forward the aggregate data message to one of the de-aggregators 142, which may split the aggregate data message into the three data segments, including the single data segment. The de-aggregator 142 may forward the three data segments, including the single data segment, to one or more re-assemblers 148 using hashing of the message identifiers. For example, the data segment having the message identifier 999 may be forwarded to a re-assembler 148(7); the single data segment (having the message identifier 1000) may be forwarded to a re-assembler 148(1); and so forth.

The re-assemblers 148 may reassemble the data segments into a sample data message format. Upon receiving the single data segment, the re-assembler 148(1) may determine that fragmentation is disabled, and, thus, that all data segments for the sample data message have been received. Therefore, the re-assembler 148(1) may place the sample data message in the second message queue 152. One of the API senders 158 may retrieve the sample data message from the second message queue 152 and send the sample data message to the data sink 110.

In a fourth example implementation, an aggregate data message may be lost. The sample engine 116 may collect a sample data message according to one or more sampling rules and push the sample data message to the first message queue 122 of the sender 104. The sample data message may have a message identifier of 1000 and may include metadata and the large payload.

In some aspects, the sender 104 may generate a plurality of data segments, of the one or more data segments, based on a sample data message of the one or more sample data messages. For example, one of the fragmentors 126 may retrieve the sample data message from the first message queue 122 and generate the plurality of data segments based on the sample data message because the sample data message has a large payload. For example, the fragmentor 126 may create 20 data segments based on the sample data message. The first data segment may have a message identifier of 1000, a segmentation flag set to “ON” (e.g., “1”), an “IsLast” indicator indicating that the first data segment is not a last data segment generated from the sample data message (e.g., a bit set to “0”), and a data segment identifier of 0; the second data segment may have a message identifier of 1000, a segmentation flag set to “ON” (e.g., “1”), an “IsLast” indicator indicating that the first data segment is not a last data segment generated from the sample data message (e.g., a bit set to “0”), and a data segment identifier of 1; and so forth. The twentieth data segment may have a message identifier of 1000, a segmentation flag set to “ON” (e.g., “1”), an “IsLast” indicator indicating that the first data segment is a last data segment generated from the sample data message (e.g., a bit set to “1”), and a data segment identifier of 19.

An aggregator 130 may combine multiple data segments, including the plurality of data segments, received from one or more fragmentors 126 to generate one or more aggregate data messages. For example, a first aggregate data message may include a count field indicating that the aggregate data message includes three data segments having message identifiers 999, 1000, and 1001, respectively. The data segment having the message identifier of 1000 may have a data segment identifier of 0. A second aggregate data message may include a count field indicating that the aggregate data message includes ten data segments. The ten data segments may each have message identifier 1000 and respective data segment identifiers 1-10. A third aggregate data message may include a count field indicating that the aggregate data message includes ten data segments. Nine of the data segments may have message identifier 1000 and respective data segment identifiers 11-19, and the tenth data segment may have message identifier 1002. One or more of the message senders 134(1)-134(P) may send the aggregate data messages to the receiver 108.

In some examples, the first aggregate data message may be lost. For example, the first aggregate data message may be lost due to unreliable conditions of the network channel 106. In some examples, the receiver 108 may not receive the first aggregate data message and may receive the second and third aggregate data messages.

In some aspects, the receiver 108 may, in connection with at least one of the one or more aggregate data messages being lost, drop one or more of the plurality of data segments and transmit a request for the plurality of data segments. For example, the load balancer 138 may forward the second and third aggregate data messages to one or more of the de-aggregators 142, which may split the aggregate data message into the multiple data segments, including the plurality of data segments. The de-aggregator 142 may forward the multiple data segments, including the plurality of data segments, to one or more re-assemblers 148 using hashing of the message identifiers. For example, for the second aggregate data message, all of the data segments (having the message identifier 1000) may be forwarded to the re-assembler 148(1). For the third aggregate data message, the data segments having the message identifier 1000 may be forwarded to the re-assembler 148(1), and the data segment having the message identifier 1002 may be forwarded to a re-assembler 148(5).

The re-assembler 148(1) may attempt to reassemble the data segments into a sample data message format. For example, the re-assembler 148(1) may first receive the data segments having segment identifiers 1-19 and wait for the data segment having segment identifier 0 before generating the sample data message. However, because the first aggregate data message carrying the data segment having segment identifier 0 was lost, the re-assembler 148(1) may not receive the data segment having segment identifier 0 before the timer 154 (e.g., a re-assembly timer) expires. In some examples, the timer 154 may start upon the re-assembler 148(1) receiving a first data segment of the plurality of data segments. Upon expiration of the timer 154, the data segment having segment identifier 0 may still be missing. As a result, the re-assembly operation may fail, the receiver 108 may drop the data segments having segment identifiers 1-19, and the receiver 108 may transmit the request for the plurality of data segments. For example, the receiver 108 may transmit a request for the sender 104 to re-transmit the plurality of data segments.

The data sampling framework may help to improve efficiency of processing or memory resource consumption. For example, storing the one or more sample data messages in the first message queue 122 or the second message queue 152 may help to relieve back-pressure automatically, thereby avoiding overconsumption of processing or memory resources. For example, if the sample data messages stored in the first message queue 122 or second message queue 152 are experiencing slowness, then those sample data messages may be dropped. In this manner, the messaging queues may help to release back-pressure. Furthermore, the data sampling framework may permit the sampling engine 116 to perform efficiently. For example, instead of waiting for back-pressure to resolve, the sampling engine 116 may store sample data messages in collocated messaging queues (e.g., the first message queue 122 and/or the second message queue 152), and may perform one or more other operations as needed (e.g., batch, retry, backoff, or the like). Load-balancing the one or more aggregate data messages may help to further reduce processing or memory resource consumption. For example, available resources (e.g., CPU resources, memory resources, or the like) may be used efficiently by load-balancing across multiple de-aggregators 142. Generating the one or more data segments, the one or more aggregate data messages, and/or the one or more sample data messages may help to achieve transmission efficiency by reducing retransmissions in lossy networks by addressing network limitations (e.g., noise, slowness, or the like). For example, if a message with 5 MBs is lost, then the sender 104 may retransmit all 5 megabytes; however, if the message is split into five 1 MB data segments, then the sender 104 may retransmit only the 1 MB data segment that was lost.

Transmitting the one or more aggregate data messages based on the MTU may optimally size the aggregate data messages for network transmission. For example, small-sized messages may be packed together and/or large-sized messages may be scaled down to enable the aggregate data messages (which are transmitted over the network channel 106) to reach a size that approximates the MTU. Additionally, or alternatively, transmitting the one or more aggregate data messages based on the timer 154 may help to reduce delays caused by back-pressure.

As indicated above, FIGS. 1A-1B are provided as an example. Other examples may differ from what is described with regard to FIGS. 1A-1B.

FIG. 2 is a diagram of an example environment 200 in which systems and/or methods described herein may be implemented. As shown in FIG. 2, environment 200 may include a data sampling system 201, which may include one or more elements of and/or may execute within a cloud computing system 202. The cloud computing system 202 may include one or more elements 203-212, as described in more detail below. As further shown in FIG. 2, environment 200 may include a network 220, and/or a data sink device 230. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the data sampling system 201 may include one or more elements 203-212 of the cloud computing system 202, may execute within the cloud computing system 202, and/or may be hosted within the cloud computing system 202, in some implementations, the data sampling system 201 may not be cloud-based (e.g., may be implemented outside of a cloud computing system) or may be partially cloud-based. For example, the data sampling system 201 may include one or more devices that are not part of the cloud computing system 202, such as device 300 of FIG. 3, which may include a standalone server or another type of computing device. The data sampling system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The data sink device 230 may include a one or more devices capable of receiving, generating, storing, processing, providing, and/or routing information associated with data sampling, as described elsewhere herein. The data sink device 230 may include a communication device and/or a computing device. For example, the data sink device 230 may include a server, such as an application server, a client server, a web server, a database server, a host server, a proxy server, a virtual server (e.g., executing on computing hardware), or a server in a cloud computing system. In some implementations, the data sink device 230 may include computing hardware used in a cloud computing environment.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with data sampling. The device 300 may correspond to the data sampling system 201 and/or the data sink device 230. In some implementations, data sampling system 201 and/or the data sink device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

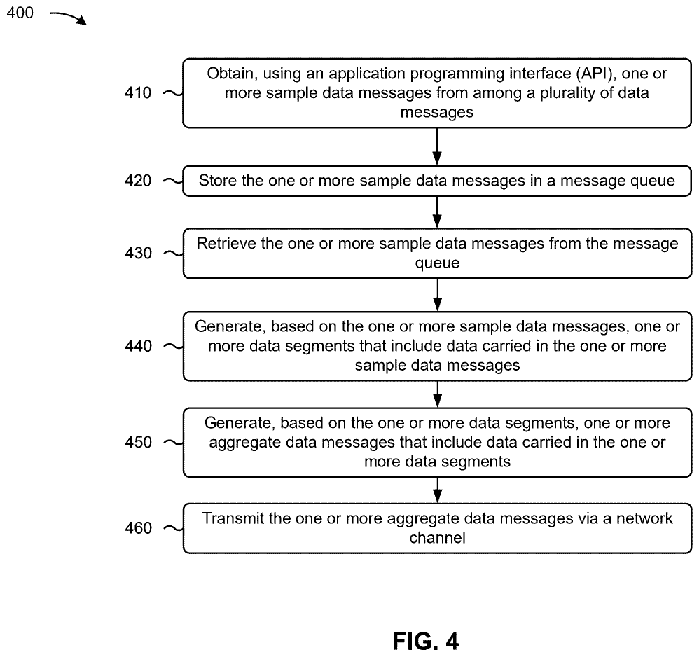

FIG. 4 is a flowchart of an example process 400 associated with data sampling. In some implementations, one or more process blocks of FIG. 4 may be performed by the data sampling system 201. In some implementations, one or more process blocks of FIG. 4 may be performed by another device or a group of devices separate from or including the data sampling system 201, such as the data sink device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, using an API, one or more sample data messages (block 410) from among a plurality of data messages. For example, the data sampling system 201 (e.g., using processor 320, memory 330, input component 340, and/or communication component 360) may obtain, using an API, one or more sample data messages from among a plurality of data messages, as described above in connection with reference number 118 of FIG. 1A. As an example, the sample engine 116 may provide the sample data message(s) to the sender 104.

As further shown in FIG. 4, process 400 may include storing the one or more sample data messages in a message queue (block 420). For example, the data sampling system 201 (e.g., using processor 320 and/or memory 330) may store the one or more sample data messages in a message queue, as described above in connection with reference number 120 of FIG. 1A. As an example, the first message queue 122 may store the one or more sample data messages.

As further shown in FIG. 4, process 400 may include retrieving the one or more sample data messages from the first message queue (block 430). For example, the data sampling system 201 (e.g., using processor 320 and/or memory 330) may retrieve the one or more sample data messages from the first message queue, as described above in connection with reference number 124 of FIG. 1A. As an example, the one or more fragmentors 126 may pull the one or more sample data messages from the first message queue 122.

As further shown in FIG. 4, process 400 may include generating, based on the one or more sample data messages, one or more data segments that include data carried in the one or more sample data messages (block 440). For example, the data sampling system 201 (e.g., using processor 320 and/or memory 330) may generate, based on the one or more sample data messages, one or more data segments that include data carried in the one or more sample data messages, as described above in connection with reference number 124 of FIG. 1A. As an example, the one or more fragmentors 126 may generate the one or more data segments.

As further shown in FIG. 4, process 400 may include generating, based on the one or more data segments, one or more aggregate data messages that include data carried in the one or more data segments (block 450). For example, the data sampling system 201 (e.g., using processor 320 and/or memory 330) may generate, based on the one or more data segments, one or more aggregate data messages that include data carried in the one or more data segments, as described above in connection with reference number 128 of FIG. 1A. As an example, the one or more fragmentors 126 may provide the one or more data segments to an aggregator 130, which may aggregate the one or more data segments into the aggregate data message(s).

As further shown in FIG. 4, process 400 may include transmitting the one or more aggregate data messages via a network channel (block 460). For example, the data sampling system 201 (e.g., using processor 320, memory 330, and/or communication component 360) may transmit the one or more aggregate data messages via a network channel, as described above in connection with reference number 132 of FIG. 1A. As an example, the aggregator 130 may provide the one or more aggregate data messages to message senders 134(1)-134(P), which may transmit the aggregate data message(s) via the network channel 106.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

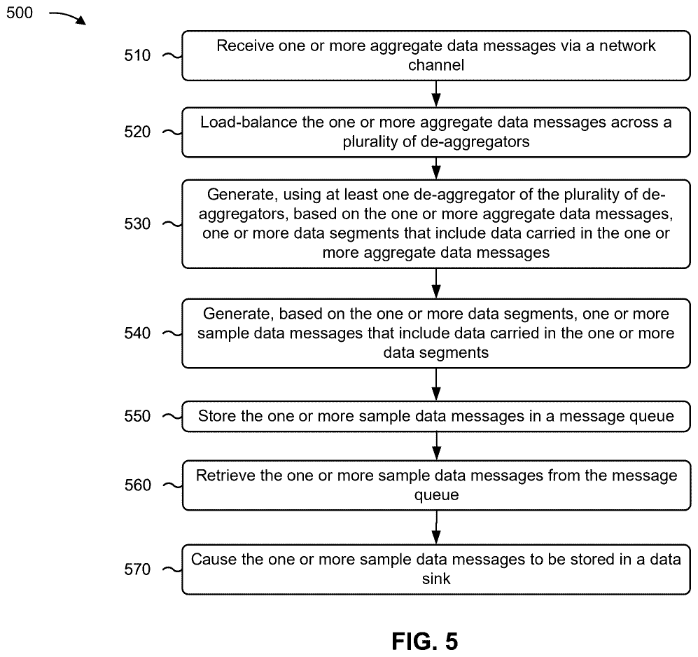

FIG. 5 is a flowchart of an example process 500 associated with data sampling. In some implementations, one or more process blocks of FIG. 5 may be performed by the data sampling system 201. In some implementations, one or more process blocks of FIG. 5 may be performed by another device or a group of devices separate from or including the data sampling system 201, such as the data sink device 230. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include receiving one or more aggregate data messages via a network channel (block 510). For example, the data sampling system 201 (e.g., using processor 320, memory 330, input component 340, and/or communication component 360) may receive one or more aggregate data messages via a network channel, as described above in connection with reference number 137 of FIG. 1B. As an example, a load balancer 138 may receive the one or more aggregate data messages from the message senders 134(1)-134(P) via the network channel 106.

As further shown in FIG. 5, process 500 may include load-balancing the one or more aggregate data messages across a plurality of de-aggregators (block 520). For example, the data sampling system 201 (e.g., using processor 320 and/or memory 330) may load-balance the one or more aggregate data messages across a plurality of de-aggregators, as described above in connection with reference number 140 of FIG. 1B. As an example, the load balancer 138 may load-balance the aggregate data messages by distributing the aggregate data messages across de-aggregators 142.

As further shown in FIG. 5, process 500 may include generating, using at least one de-aggregator of the plurality of de-aggregators, based on the one or more aggregate data messages, one or more data segments (block 530). For example, the data sampling system 201 (e.g., using processor 320 and/or memory 330) may generate, using at least one de-aggregator of the plurality of de-aggregators, based on the one or more aggregate data messages, one or more data segments, as described above in connection with reference number 140 of FIG. 1B. As an example, a de-aggregator 142 may split an aggregate data message into the one or more data segments.

As further shown in FIG. 5, process 500 may include generating, based on the one or more data segments, one or more sample data messages (block 540). For example, the data sampling system 201 (e.g., using processor 320 and/or memory 330) may generate, based on the one or more data segments, one or more sample data messages, as described above in connection with reference number 146 of FIG. 1B. As an example, the re-assembler 148 may restore the one or more sample data messages using the one or more data segments.

As further shown in FIG. 5, process 500 may include storing the one or more sample data messages in a message queue (block 550). For example, the data sampling system 201 (e.g., using processor 320 and/or memory 330) may store the one or more sample data messages in a message queue, as described above in connection with reference number 150 of FIG. 1B. As an example, the re-assembler 148 may push the one or more sample data messages to the second message queue 152 before expiration of the timer 154.

As further shown in FIG. 5, process 500 may include retrieving the one or more sample data messages from the message queue (block 560). For example, the data sampling system 201 (e.g., using processor 320 and/or memory 330) may retrieve the one or more sample data messages from the message queue, as described above in connection with reference number 160 of FIG. 1B. For example, an API sender 158 may retrieve the one or more sample data messages from the second message queue 152.

As further shown in FIG. 5, process 500 may include causing the one or more sample data messages to be stored in a data sink (block 570). For example, the data sampling system 201 (e.g., using processor 320 and/or memory 330) may cause the one or more sample data messages to be stored in a data sink, as described above in connection with reference number 160 of FIG. 1B. As an example, the API sender 158 may transmit, and the data sink 110 may receive, the one or more sample data messages.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for data sampling, the system comprising:
a first device comprising:
one or more memories; and
one or more processors, communicatively coupled to the one or more memories, configured to:
obtain, using an application programming interface (API), one or more sample data messages from among a plurality of data messages;
store the one or more sample data messages in a first message queue;
retrieve the one or more sample data messages from the first message queue;
generate, based on the one or more sample data messages, one or more data segments that include data carried in the one or more sample data messages;
generate, based on the one or more data segments, one or more aggregate data messages that include data carried in the one or more data segments; and
transmit the one or more aggregate data messages via a network channel; and
a second device comprising:
one or more memories; and
one or more processors, communicatively coupled to the one or more memories, configured to:
receive the one or more aggregate data messages via the network channel;
load-balance the one or more aggregate data messages across a plurality of de-aggregators;
generate, using at least one de-aggregator of the plurality of de-aggregators, based on the one or more aggregate data messages, the one or more data segments;
generate, based on the one or more data segments, the one or more sample data messages;
store the one or more sample data messages in a second message queue;
retrieve the one or more sample data messages from the second message queue; and
cause the one or more sample data messages to be stored in a data sink.

2. The system of claim 1, wherein each of the one or more sample data messages comprises an API sample data format that includes a message identifier field, a metadata field, and a payload field.

3. The system of claim 1, wherein each of the one or more data segments includes a message identifier field, a segmentation flag field, a segment identifier field, and a data field.

4. The system of claim 1, wherein each of the one or more aggregate data messages includes a count field, one or more segment length fields, and one or more segment data fields corresponding to the one or more segment length fields.

5. The system of claim 1, wherein the one or more processors of the first device, to generate the one or more data segments based on the one or more sample data messages, are configured to generate a single data segment, of the one or more data segments, based on a sample data message of the one or more sample data messages, and wherein the one or more processors of the second device, to generate the one or more sample data messages based on the one or more data segments, are configured to generate the sample data message based on the single data segment.

6. The system of claim 5, wherein a segmentation flag of the single data segment is set to on.

7. The system of claim 5, wherein a segmentation flag of the single data segment is set to off.

8. The system of claim 1, wherein the one or more processors of the first device, to generate the one or more data segments based on the one or more sample data messages, are configured to generate a plurality of data segments, of the one or more data segments, based on a sample data message of the one or more sample data messages, and wherein the one or more processors of the second device, to generate the one or more sample data messages based on the one or more data segments, are configured to generate the sample data message based on the plurality of data segments.

9. The system of claim 8, wherein the one or more processors of the second device are further configured to:
in connection with at least one of the one or more aggregate data messages being lost:
drop one or more of the plurality of data segments; and
transmit a request for the plurality of data segments.

10. The system of claim 1, wherein the one or more processors of the first device, to transmit the one or more aggregate data messages, are configured to transmit the one or more aggregate data messages based on one or more of a maximum transmission unit (MTU) or a timer.

11. A method of data sampling, comprising:
obtaining, using an application programming interface (API), one or more sample data messages from among a plurality of data messages,
wherein each of the one or more sample data messages comprises an API sample data format that includes a message identifier field, a metadata field, and a payload field;
storing the one or more sample data messages in a message queue;
retrieving the one or more sample data messages from the message queue;
generating, based on the one or more sample data messages, one or more data segments that include data carried in the one or more sample data messages,
wherein each of the one or more data segments includes the message identifier field, a segmentation flag field, a segment identifier field, and a data field;
generating, based on the one or more data segments, one or more aggregate data messages that include data carried in the one or more data segments,
wherein each of the one or more aggregate data messages includes a count field, one or more segment length fields, and one or more segment data fields corresponding to the one or more segment length fields; and
transmitting the one or more aggregate data messages via a network channel.

12. The method of claim 11, wherein generating the one or more sample data messages based on the one or more data segments includes generating the one or more sample data messages based on a single data segment.

13. The method of claim 12, wherein a segmentation flag of the single data segment is set to on.

14. The method of claim 12, wherein a segmentation flag of the single data segment is set to off.

15. A method of data sampling, comprising:
receiving one or more aggregate data messages via a network channel,
wherein each of the one or more aggregate data messages includes a count field, one or more segment length fields, and one or more segment data fields corresponding to the one or more segment length fields;
load-balancing the one or more aggregate data messages across a plurality of de-aggregators;
generating, using at least one de-aggregator of the plurality of de-aggregators, based on the one or more aggregate data messages, one or more data segments that include data carried in the one or more aggregate data messages,
wherein each of the one or more data segments includes a message identifier field, a segmentation flag field, a segment identifier field, and a data field;
generating, based on the one or more data segments, one or more sample data messages that include data carried in the one or more data segments,
wherein each of the one or more sample data messages comprises an API sample data format that includes the message identifier field, a metadata field, and a payload field;
storing the one or more sample data messages in a message queue;
retrieving the one or more sample data messages from the message queue; and
causing the one or more sample data messages to be stored in a data sink.

16. The method of claim 15, wherein generating the one or more sample data messages based on the one or more data segments includes generating a sample data message, of the one or more sample data messages, based on a single data segment of the one or more data segments.

17. The method of claim 16, wherein a segmentation flag of the single data segment is set to on.

18. The method of claim 16, wherein a segmentation flag of the single data segment is set to off.

19. The method of claim 15, wherein generating the one or more sample data messages based on the one or more data segments, includes generating a sample data message, of the one or more sample data messages, based on a plurality of data segments of the one or more data segments.

20. The method of claim 19, further comprising:
in connection with at least one of the one or more aggregate data messages being lost:
dropping one or more of the plurality of data segments; and
transmitting a request for the plurality of data segments.
